(19) United States
(12) Patent Application Publication
(10) Pub. No.: US 2017/0278124 A1
(43) Pub. Date: Sep. 28, 2017

(54) MERCHANT LOYALTY ACCOUNT ENROLLMENT THROUGH PAYMENT CHECKOUT PLATFORM SERVICES

(71) Applicant: VISA INTERNATIONAL SERVICE ASSOCIATION, San Francisco, CA (US)

(72) Inventors: Thomas Purves, San Francisco, CA (US); Guyon Krug, San Francisco, CA (US)

(21) Appl. No.: 15/082,790

(22) Filed: Mar. 28, 2016

(51) Int. Cl. G06Q 30/02

(52) U.S. Cl. CPC G06Q 30/0229

(57) ABSTRACT

A system for registering a user across different transactional platforms. A transaction server provides via an interface a first user interface (UI) requesting the user to provide information to register with a first transactional platform. A data store stores the provided information from the user in a user profile. The transaction server provides via the interface a second UI requesting the user to register a loyalty program via a communications network hosted by a second transactional platform associated with a merchant. In response to the user registering the loyalty program, the transaction server provides a portion of the stored information from the data store to the second transactional platform to complete registering the user to the loyalty program. The transaction server processes promotional transactions during checkout for the user via the transactional platform as a result of the information associated with the loyalty program in the user profile.

### BACKGROUND

Merchants have been introducing loyalty programs to consumers to recognize their loyalty to respective brands. These loyalty programs have also been used to help merchants to provide more directed marketing. As a result, merchants could direct more resources to improve sales, etc.

One approach has been for the merchants to work closely with charge card issuers and banks to issue co-branded charge cards. For example, it is known for a merchant, such as a retail store or even an educational institution, and a bank to co-brand a credit card for its customers or alumni to use the credit card. The customers or alumni might receive loyalty rewards, such as reward points or free items or merchandise.

The other known approach is to have a non-credit-card loyalty program that is separate from a consumer's own credit card. This approach may be better for the merchant because the merchant does not need to be concerned with paying fees related to co-brand a credit card. This approach is also easier to manage as some of the loyalty programs does not need to be associated with transactions or purchases.

Regardless of the kinds of loyalty programs above, every consumer is familiar with the repeated information entry that is associated with these different loyalty program enrollment forms. Most of these programs request similar, if not identical, information, such as name, billing address, contact number, or email address.

There have been many technical approaches or solutions in the prior art. Most of them involved with enabling a browser associated with the consumer's device to remember information for some fields of the form. That way, when the consumer does not need to enter the same information repeatedly. The shortcoming of this approach is that the browser-dependent technique requires the consumer uses the same browser on the same computing device. Some browsers allow portability of this capability, but the information not have been formatted properly. Moreover, this approach also depends on the form fields of the web pages of the loyalty program enrollment; that is, the fields need to be properly assigned or defined.

Therefore, a more reliable but also convenient approach is desirable.

### SUMMARY

The following presents a simplified summary of the present disclosure in order to provide a basic understanding of some aspects of the disclosure. This summary is not an extensive overview. It is not intended to identify key or critical elements of the disclosure or to delineate its scope. The following summary merely presents some concepts in a simplified form as a prelude to the more detailed description provided below.

Embodiments of the invention establish an online payment checkout platform infrastructure as an information provision provider to another information platform such as during an enrollment of a merchant loyalty program. That is, aspects of the invention enable information from the consumer's information in the payment checkout platform to be provided to the loyalty program during enrollment process. In addition, based on the interoperability of information sharing, with additional location information from global positioning satellite (GPS) or other location-information-identifiers associated with a mobile device carried by a consumer, the payment checkout platform may intelligent provide loyalty program enrollment and promotional offers based on the additional location information.

Embodiments of the invention further solve technical problems and challenges securely sharing data in online forms across different user platforms as well as backend platforms without relying on web browsers or requiring users to memorize and retype the requested information. Embodiments use a payment checkout platform as the basis for all associated loyalty program enrollment forms such that the requested information is shared securely and accurately. The payment checkout platform also does not retrieve or copy browser-based forms. The payment checkout platform further avoids using information from browser-based profiles. Users are not required to be on any specific client device, browser, or app. The loyalty program merchants do not need to be in the same platform as the payment checkout platform—as long as they provide information of the formats of the formed data to the payment checkout platform.

### BRIEF DESCRIPTION OF THE DRAWINGS

The invention may be better understood by references to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 illustrates an overview of a payment checkout platform according to one embodiment of the invention;

FIGS. 2-10 illustrate a series of exemplary screen shots of a portion of a payment checkout platform system according to one embodiment of the invention;

FIG. 11 illustrates a flowchart of a method of a payment checkout platform system according to one embodiment of the invention;

FIG. 12 is an illustration of another aspect of a payment checkout platform system according to one embodiment of the invention;

FIG. 13 is an illustration of a portable computing device; and

FIG. 14 is an illustration of a server computing device.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein.

### DETAILED DESCRIPTION

The present invention now will be described more fully with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description is, therefore, not to be taken in a limiting sense.

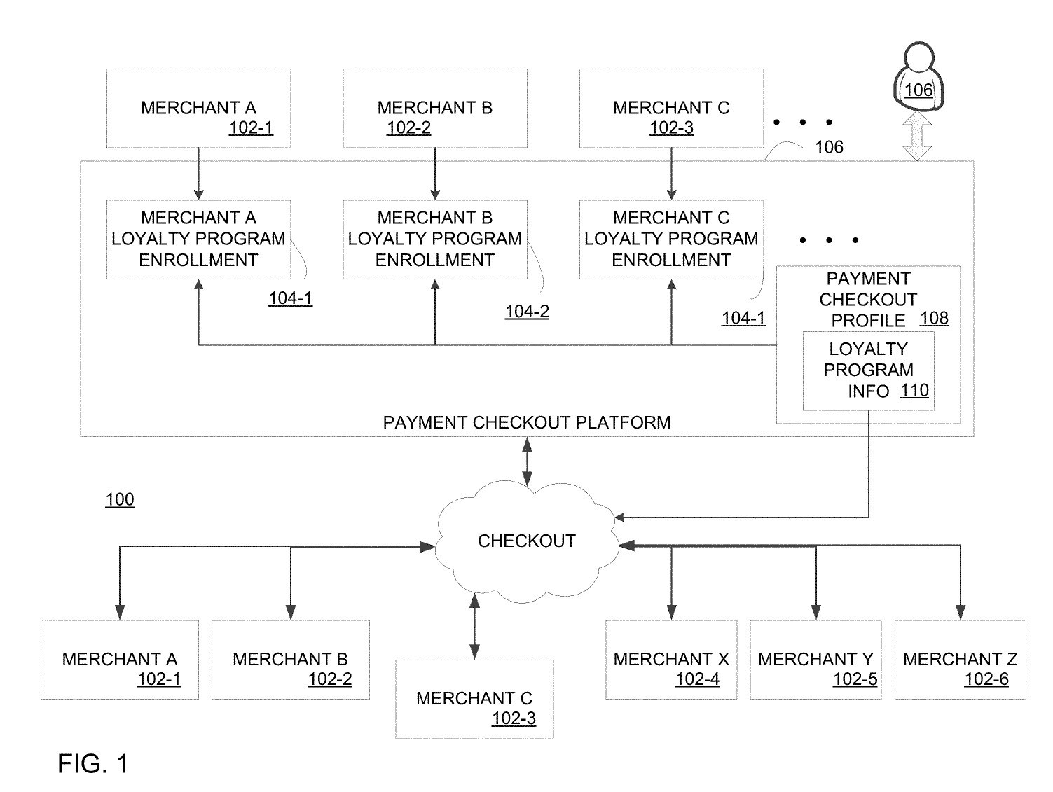

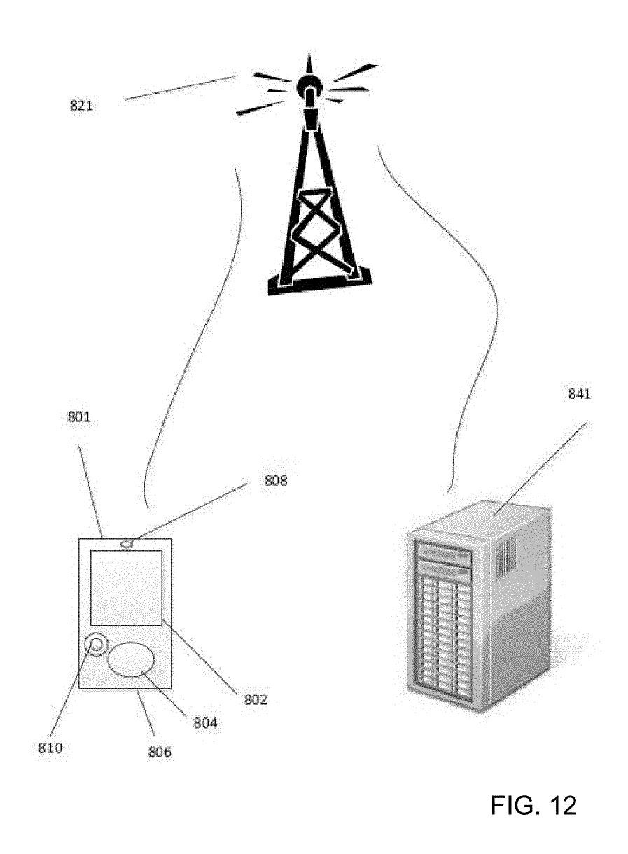

Referring now to FIG. 1, an overview of a payment checkout platform 100 according to one embodiment of the invention may be illustrated. In one embodiment, the payment checkout platform 100 is a comprehensive computer network with computing devices interconnected with frontend servers, backend servers, databases, data protocols, etc., for enabling online checkout process/procedures. For example, the payment checkout platform 100 may include backend databases or data stores for storing data associated with consumers/users of the platform 100, may include frontend interfaces, such as websites for both stationary computers and mobile computers, may include client-based applications or “apps” to be installed on mobile computers. See also the description of FIGS. 12-14 below which may provide additional detail. In one embodiment, the payment checkout platform 100 may include the proprietary electronic payment network of VisaNet® and Visa Checkout® with transaction servers. In another embodiment, the payment checkout platform 100 may include application program interface (API) or interfaces, hardware or otherwise, to interact with other platforms or data infrastructures to exchange data.

As an illustration, and not to be taken in a limiting sense, a consumer 106 is associated with the payment checkout platform 100. The consumer 106 uses the payment checkout platform 100 to interact with one or more merchants 102. As illustrated, merchant A 102-1, merchant B 102-2, merchant C 102-3 . . . to merchants 102-N may be connected with the payment checkout platform 100 under other transactional platforms or servers. According to the embodiments of the invention, merchants A-C 102-1 through 102-3 may have their respective loyalty programs 104-1 through 104-3 for any consumer to register or sign up. Instead of having the consumer 106 complete the enrollment forms for the loyalty programs 104-1 to 104-3 repeatedly, the payment checkout platform 100 applies relevant information from a payment checkout profile 108 of the consumer 106 to the forms in the enrollment 104 process.

For example, the payment checkout profile 108 may have basic information such as name, billing address, phone number, etc. In one embodiment, before populating the forms in the enrollment process 104, the payment checkout platform 100 pre-determines what is the most relevant information needed during the enrollment process 104. In one example, suppose the payment checkout platform 100 stores both the business address and home address information of the consumer 106. As such, when the payment checkout platform 100 determines that a merchant's loyalty program tends to be used for business (e.g., by nature of the merchant or agreements between that and the payment checkout platform 100), the payment checkout platform 100 may provide the business address of the consumer 106 when the consumer 106 wishes to sign up or register for the loyalty program. In another example, the payment checkout profile 108 may include information such security questions and answers, checkout history, etc. The payment checkout platform 100 may determine that these data would not be relevant for the enrollment process 104, even if the enrollment forms may request such information. As such, the payment checkout platform 100 strikes a balance between providing convenience to the consumer 106 and ensuring privacy and security to the consumer 106. It is to be understood that the availabilities of the merchants 104 to the payment checkout platform 100 may be established via agreements between the merchants 104 and the consumer 106 has the opportunity to join after agreeing to any terms or conditions associated therewith.

The resulted convenience to the consumer 106 is a result of the proposed solution to at least one technical challenge associated with securely sharing data in online forms across different user platforms as well as backend platforms. Currently, the consumer 106 would either suffer through the repeated entry of information on those forms or would need to rely on browser profiles that have stored those same information. However, when the consumer 106 is not around the computing device where the browser profile is associated with or the consumer 106 is associated with the computing device but the browser profile is for another individual, the consumer 106 would have no recourse except to enter the information. Therefore, it is no longer a preference of a user, but this technical feature will facilitate all users. Embodiments of the invention employ the payment checkout platform 100 as the basis or common source for all associated loyalty program enrollment forms such that the requested information is shared securely and accurately. Users are not required to be on any specific client device, browser, or app. The loyalty program merchants do not need to be in the same platform as the payment checkout platform—as long as they provide information of the formats of the formed data to the payment checkout platform. At the same time, the payment checkout platform 100 provides the loyalty program information when appropriate.

According to another embodiment, the payment checkout platform 100 stores, as part of the payment checkout profile 108, loyalty program information 110 for all the loyalty programs that the consumer 106 has enrolled or for which the consumer has signed up. The loyalty program information 110 includes loyalty programs that the consumer 106 signs up with the payment checkout platform 100 or adds the programs that he or she has previously enrolled.

By having the loyalty program information 110 in the payment check profile 108 for the consumer 106, the payment checkout platform 100 makes the loyalty program information available at checkout with the merchants 102. For example, if the consumer 106 is also a loyalty program member of the merchant A 102-1, the payment checkout platform 100 retrieves information from the information 110 during an online checkout for purchases at the merchant A 102-1. In another example, suppose the consumer 106 uses the payment checkout platform 100 to perform a checkout for purchases at the merchant B 102-2. Suppose also that the merchant A 102-1 and the merchant B 102-2 has cross- or joint-affiliation such that they recognize each other's loyalty program membership. For example, the merchant A may be The Gap branded apparel retailer and the merchant B may be the BANANA REPUBLIC branded apparel retailer. While they appear to be separate apparel stores, they are different brands under Gap, Inc. They each have their own loyalty programs. In this situation, suppose the consumer 106 is not a member of the merchant B 102-2's loyalty program, but he or she is a member of the loyalty program of the merchant A 102-1. At the time of checkout, the payment checkout platform 100 may present the loyalty program information for the merchant A 102-2 from the loyalty program information 110 at the checkout of the merchant B 102-2.

As an extension of the above example, suppose the consumer 106 is also a member of the merchant B 102-2 loyalty program. The payment checkout platform 100 may present both loyalty program information at the checkout in response to a number of additional information at the time of the checkout, such as location information associated with a mobile device of the consumer 106, past transaction history, etc. As such, the consumer 106 may have the opportunity to choose the most preferred loyalty program at checkout. Aspects of the invention provide this convenience especially for purchasing travel services or products because many travel service providers each has its own loyalty program but they are also part of a global alliance. Additionally, many lodging or accommodation loyalty programs provide reward points to the air travel providers of the consumer's choice. As a result, the payment checkout platform 100 overcomes a technical challenge, and the proposed solution facilitates the consumer 106 in applying the appropriate loyalty program.

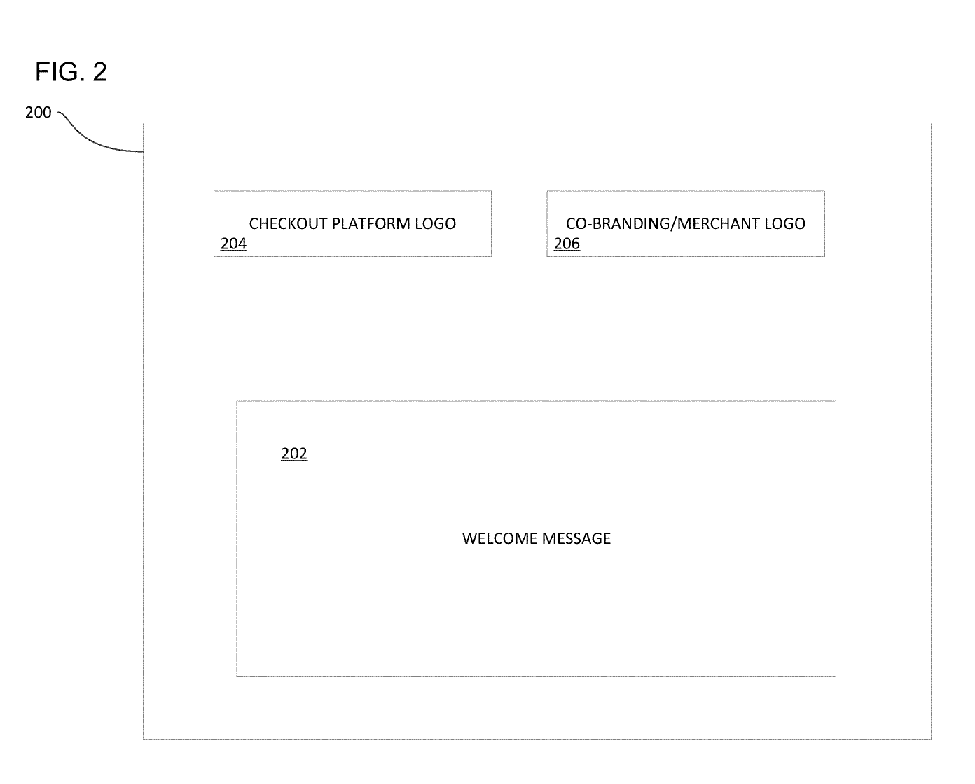

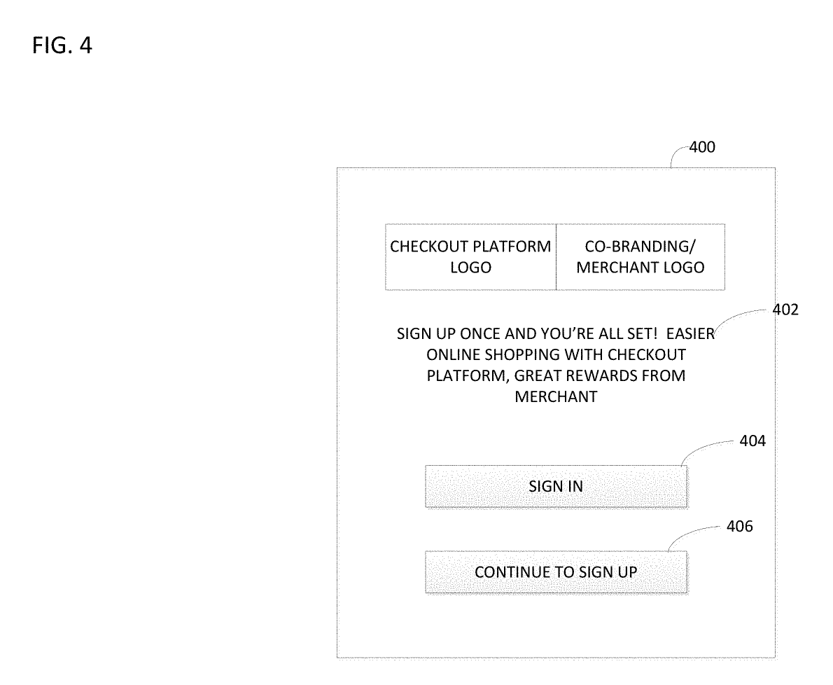

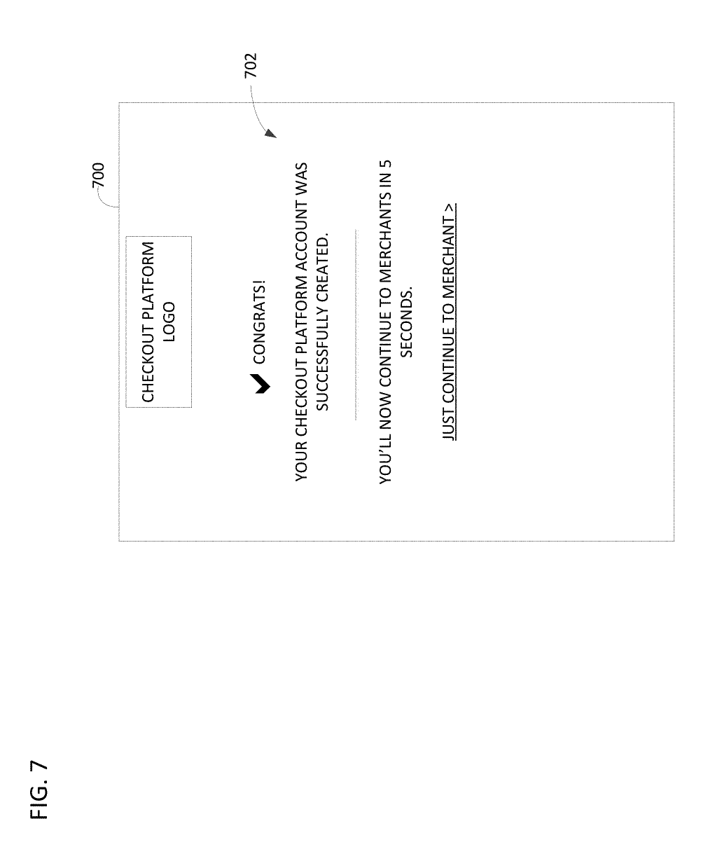

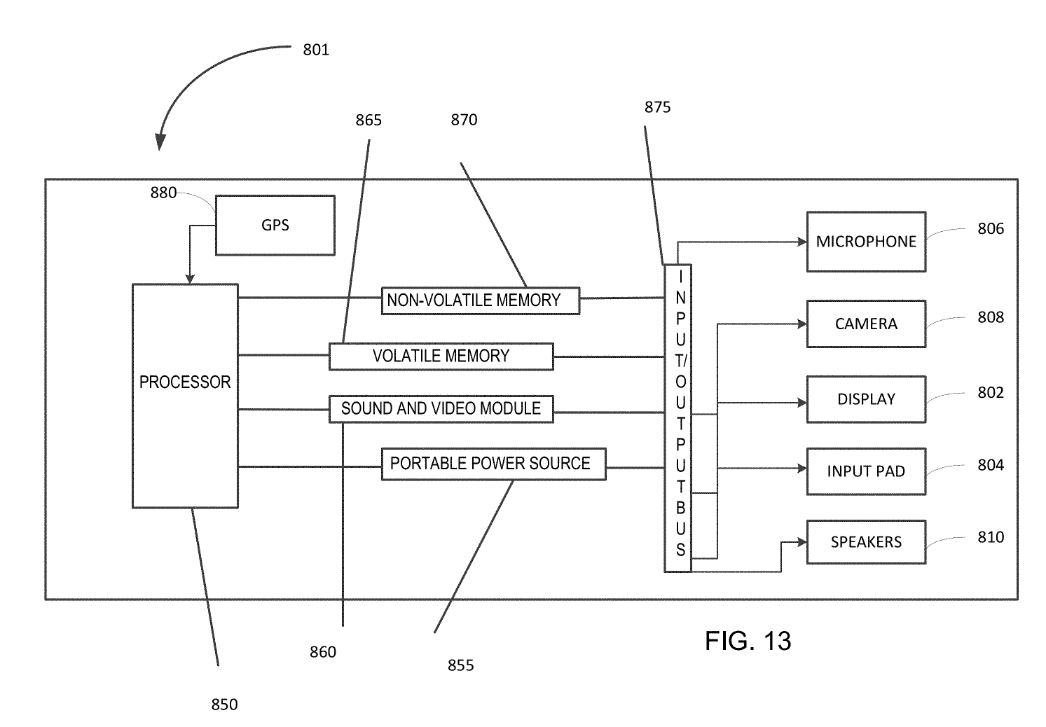

Referring now to FIGS. 2-10, a series of exemplary screenshots illustrate a portion of a payment checkout platform system according to one embodiment of the invention. In FIG. 2, the consumer 106 is shown an interface 200 showing a welcome message 202 to greet the consumer 106 about the promotional offers. The promotional offers are provided as a collaboration between the payment checkout platform 100 and the merchant 102. Their respective logos or marks, 204 and 206, are shown in the interface 200. It is to be understood that these screenshots in FIGS. 2-10 are provided to the mobile device, such as a device shown in FIG. 13, associated with the consumer 106. In one embodiment, the screenshots in FIGS. 2-10 may be displayed at a kiosk when the consumer 106 uses to checkout at the merchant 102 location.

In one embodiment, the interface 200 may be displayed in response to the actions of the consumer 106 to checkout an item or service using the payment checkout platform 100. In another embodiment, the interface 200 may be displayed when the consumer 106 is identified in a close proximity to the merchant 102 based on a mobile device associated with the consumer 106.

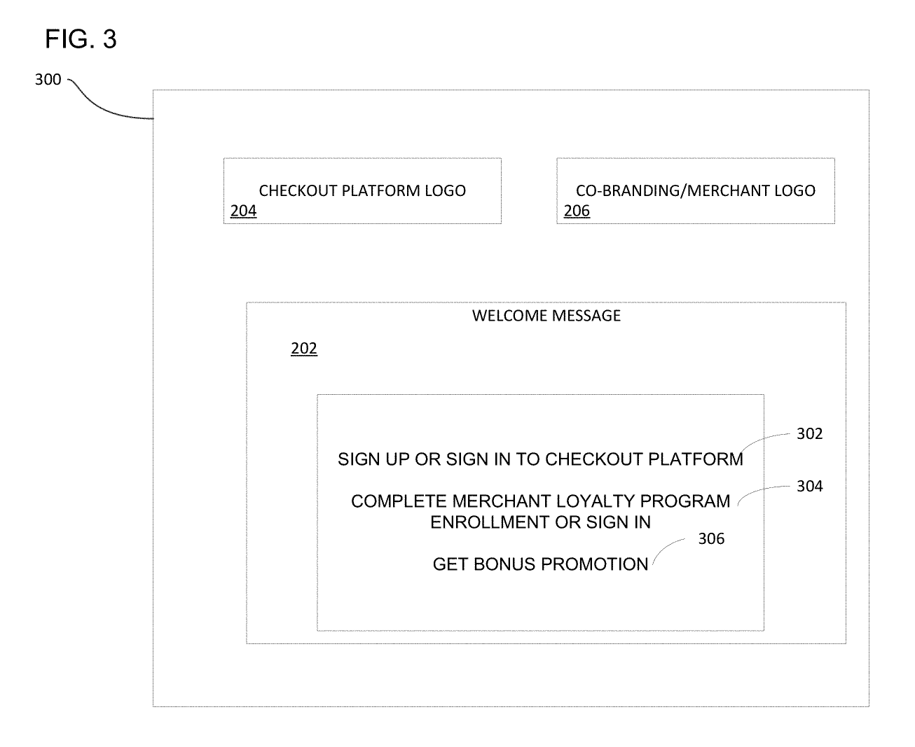

The consumer 106 selects on the welcome message 202 by interacting with the interface 200 to a next interface 300 in FIG. 3. In FIG. 3, the consumer 106 may be presented with three optional interactive choices: option 302, Register/Sign up or sign in to the checkout platform, such as the payment checkout platform 100; option 304, complete merchant loyalty program enrollment or sign in; or option 306, get bonus promotion. These options are provided in the event that the consumer 106 wishes to change his or her mind about the payment checkout platform 100 or the merchant loyalty program 104, or just wants to obtain the bonus promotion as a tryout or an invitation.

If the consumer 106 selects the option 302, an interface 400 is provided to the consumer 106. The consumer 106 is presented with a message 402 briefly describing and introducing the consumer 106 to the features to be followed. The interface 400 also includes two choices for the consumer 106 to choose: 404 to sign in to the payment checkout platform 100 that the consumer 106 is already a member, or 406 to sign up or register to the payment checkout platform 100 to use it to conduct the checkout process.

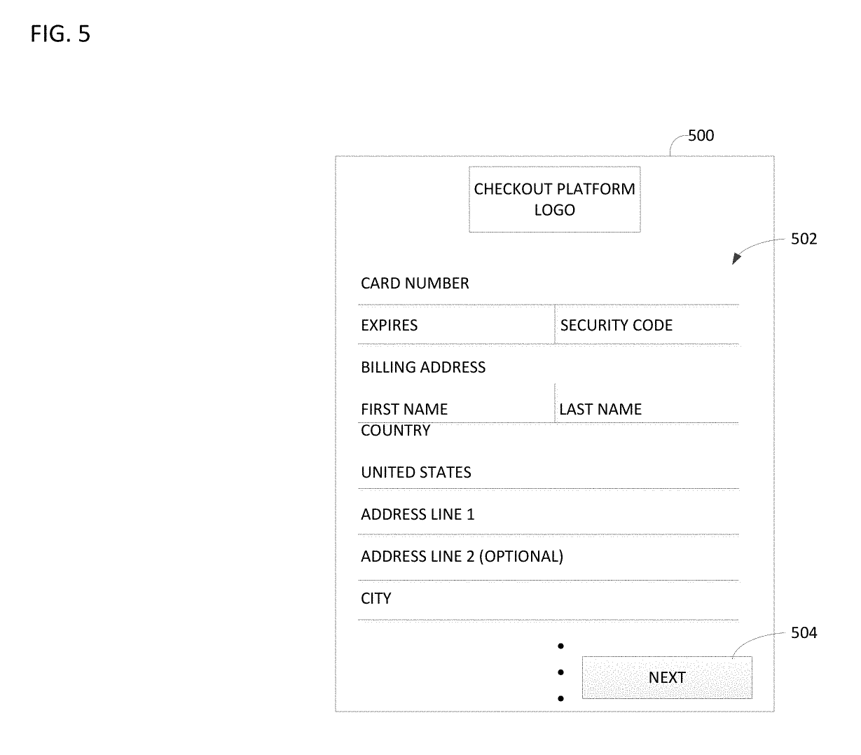

Referring to FIG. 5, the consumer 106 is presented with an interface 500 once the consumer 106 selects the option 406. This interface 500 provides a sign-up form 502 to receive information from the consumer 106. The sign-up form 502 includes information such as name, address, charge card to be used for the payment, and other contact information. Once the consumer 106 is finished with entering the information requested in the sign-up form 502, the consumer 106 may select a NEXT button 504 to proceed to the next interface 600.

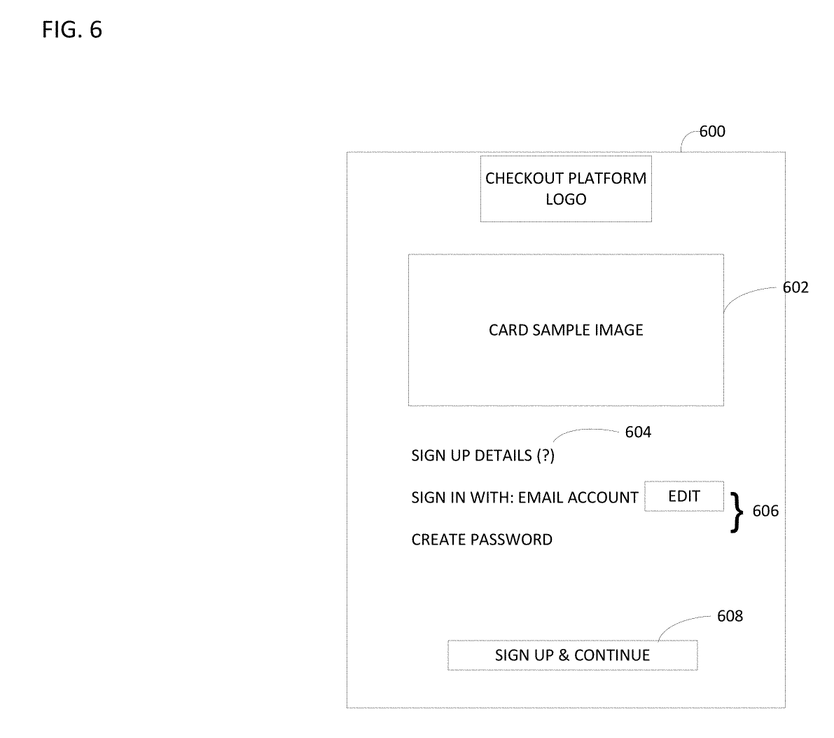

Referring to FIG. 6, the interface 600 presents a final step of the sign-up process with the payment checkout platform 100. For example, the interface 600 includes a sample card image 602 and a review sign up information 604. The interface 600 also enables the consumer 106 to create an online account to the payment checkout platform 100 by requesting entry of information 606. Once the consumer 106 completes the information or reviews the information provided in the interface 500 or 600, the consumer 106 may select a “SIGN UP & CONTINUE” button 608 to proceed to the next interface 700 of the checkout process.

At interface 700, the consumer 106 is presented with messages 702 indicating that the sign-up process has been completed. The messages 702 may also include an automatic, but with a 5-second timer, referral to the merchant 102's website to continue the loyalty program enrollment. The messages 702 may also include a link directly to the merchant 102's loyalty program enrollment 104, in the event that the consumer 106 does not wish to wait for the 5-second timer to expire.

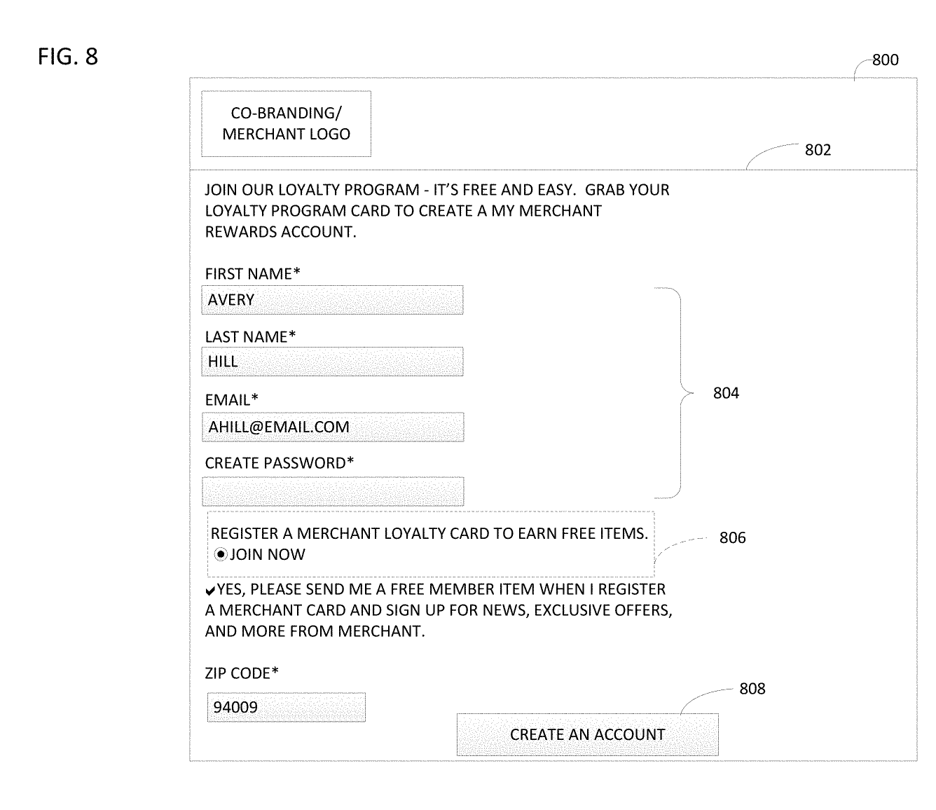

Either after the expiration of the timer or through the direct link, the consumer 106 is presented with an interface 800 in FIG. 8 showing a content panel 802. The content panel 802 includes an introductory or brief statement about the merchant's loyalty program. The panel 802 also shows a plurality of fields in 804, which will be filled automatically by the payment checkout platform 100 using the relevant information from the payment checkout profile 108, as described above. In addition, for the purpose of illustration only, a panel 806 with a “join-now” button being pre-selected. This panel 806 would not be visible to the consumer 106 because this is automatically selected for the consumer 106 by the payment checkout platform 100. In another embodiment, the panel 802 may be displayed with a lighter grey or other indicia that indicates to the consumer 106 that the filled without inputs from the consumer 106. In a further embodiment, the panel 802 may display an indicia, instead of fields, to the consumer 106 that the form fields have been filled based on the payment checkout profile 108. This embodiment would be helpful when the display size of the consumer 106 is truncated or has limited display real estate. Once the consumer 106 confirms the information in the fields 804, the consumer 106 would select the option “CREATE AN ACCOUNT” button 808. In the embodiment that the form filled information is not shown or provided to the consumer 106, the interface 800 may have an alternative button (not shown) requesting the payment checkout platform 100 to show the form filled information.

Also shown in the interface 800, the merchant 102's logo or mark is shown. This is to distinguish over the previous screenshots such that the payment checkout platform 100 logo or mark is displayed.

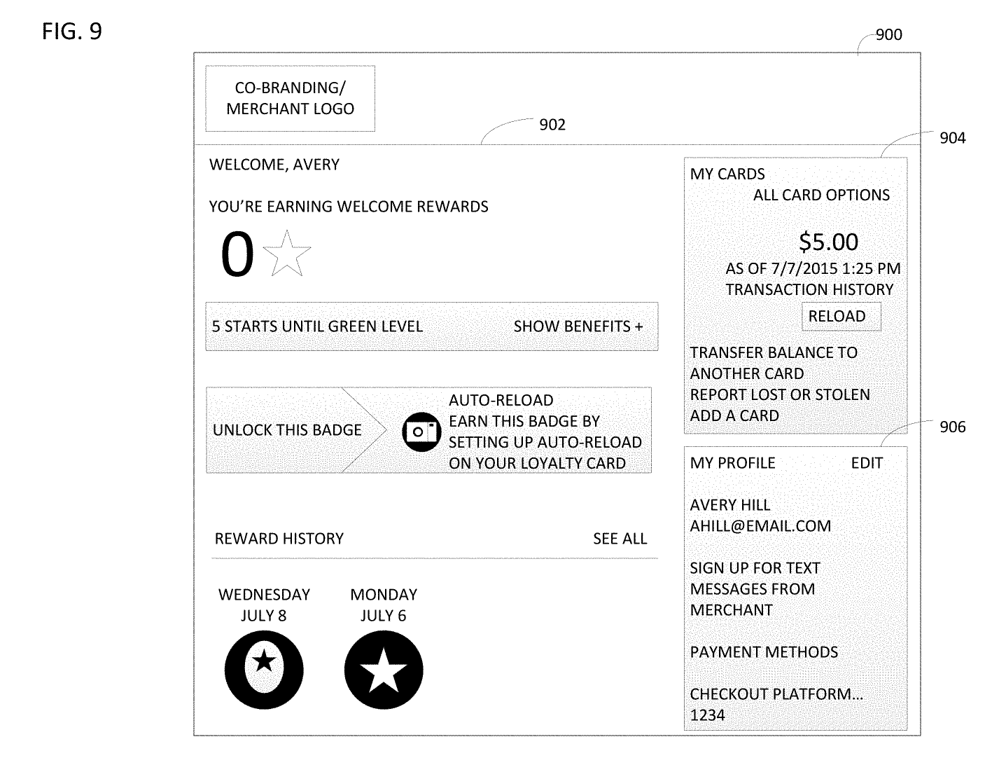

Referring now to FIG. 9, an interface 900 illustrates an exemplary interface of the loyalty program of the merchant 102. For example, the interface 900 includes a panel 902 displaying one or more aspects of the loyalty program 104. For example, the loyalty program 104 may display that a current reward type, reward point level, next reward level, benefits associated with each reward level, reward history, etc. The interface 900 also may display another panel 904 showing additional details of the loyalty program 104. For example, the panel 904 may display information about information about the loyalty program card that the consumer 106 may have or will have. The panel 904 may further disclose options or controls to further manage the loyalty program card. For example, the panel 904 displays options such as “TRANSFER BALANCE TO ANOTHER CARD,” “REPORT LOST OR STOLEN,” or “ADD A CARD”.

In another embodiment, the interface 900 may also display a panel 906 showing a profile of the consumer 106 under the loyalty program 104. Of course, as discussed previously, this panel 906's information may be derived from the payment checkout profile 108. However, the loyalty program 104 may nevertheless wish to display the information again for the consumer 106.

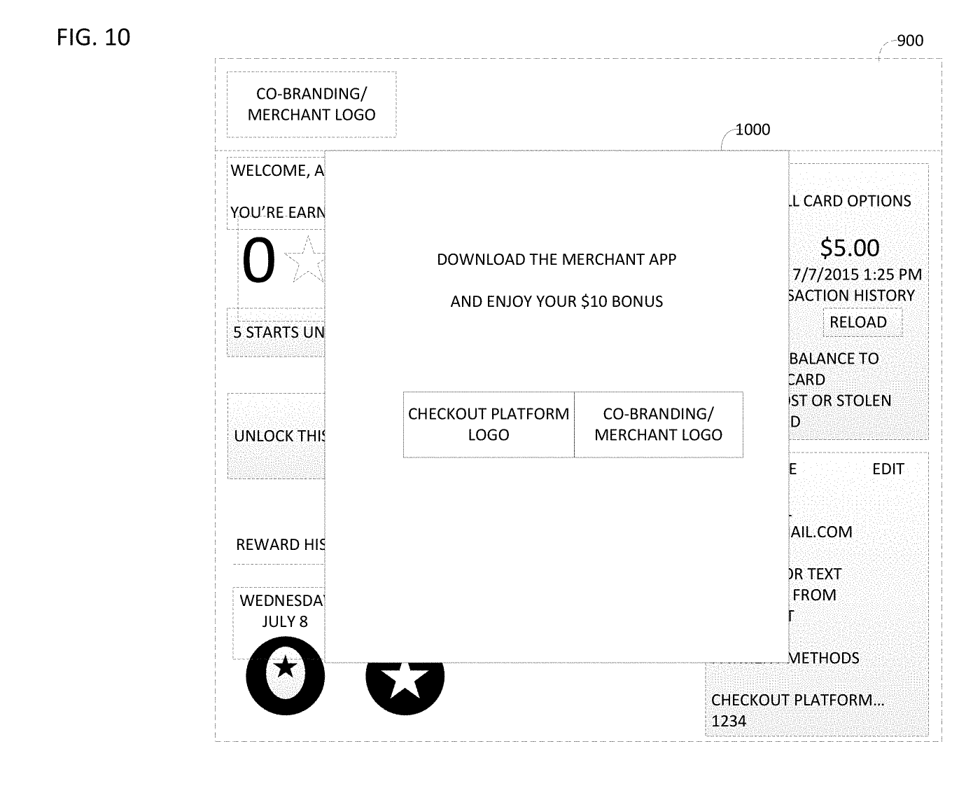

Referring now to FIG. 10, the payment checkout platform 100 may further display an interface 1000 covering substantially the interface 900, rendering a majority portion of contents of the interface 900 blocked from view to the consumer 106. In another embodiment, the interface 1000 may be displayed in one brightness or color while the interface 900 may be darkened or displayed in a different color to show the focus is now on the interface 1000. The interface 1000 may further display messages, as shown in FIG. 10, to welcome the consumer 106 to receive the bonus rewards or provide other additional offers. It is to be understood that other types of messages or offers may be provided without departing from the scope or spirit of the invention.

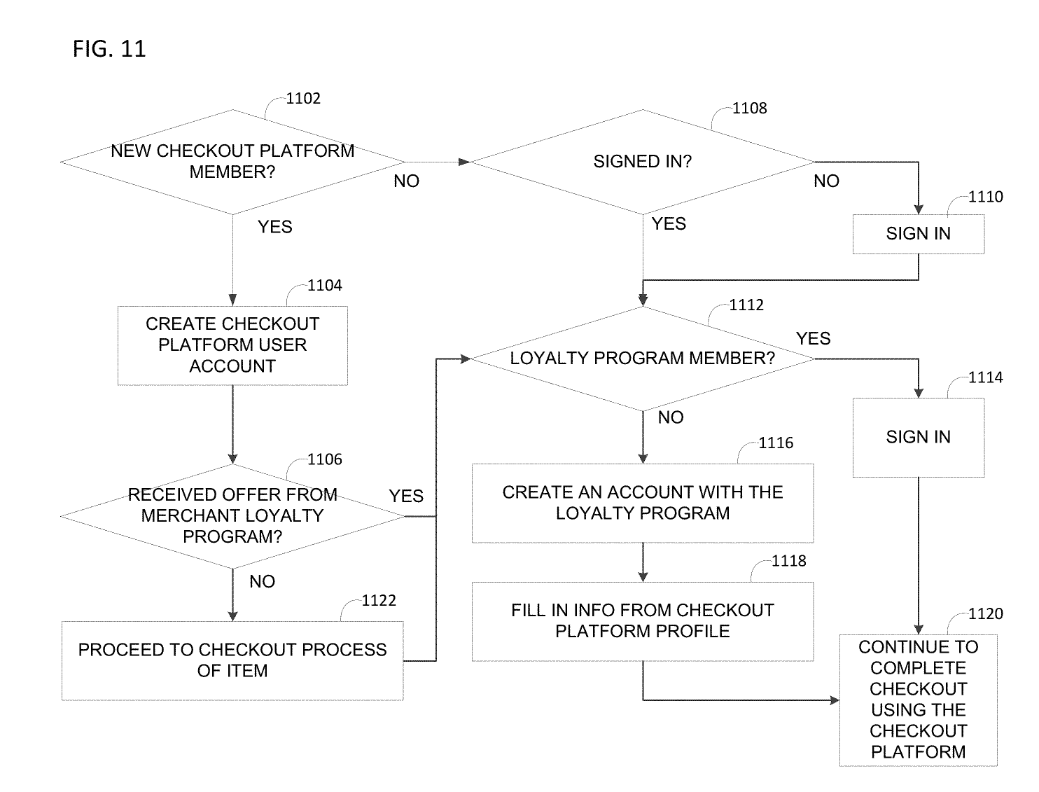

Referring now to FIG. 11, a flowchart illustrates a method according to one embodiment of the invention. In one embodiment, the method illustrated enables the payment checkout platform 100 to help a user, such as the consumer 106, to set up the merchant's loyalty program based on the payment checkout platform 100 information. In another embodiment, the flow process described below supplements or works in conjunction with the screenshots shown in FIGS. 2-10. For example, at 1102, a user is asked whether he or she is a new member of the checkout platform or whether he or she would like to become a new member. If the response is negative, the user is taken to 1108 to sign in. On the other hand, if the response is positive, the user is taken to 1104 to create a new checkout platform user account.

The user is next taken to another decision query 1106 to determine whether the user has received an offer from merchant loyalty program. If the determine is negative, the user may be taken to steps to checkout of the item or service that the user wishes to purchase at 1122. During the checkout process, the user may still be directed to determine whether the user is part of the loyalty program member at 1112. As described above, embodiments of the invention may identify location information or merchant information during the checkout process to suggest the enrollment of the loyalty program to maximize the user's opportunity to receive offers. The user is only minimally inconvenienced because the payment checkout platform will supply or apply the relevant information from the payment checkout profile to the loyalty program.

If the determination of the decision query 1106 is positive, the user is further asked whether he or she is a member of the loyalty program at 1112. The user may also reach the decision query 1112 if the user has signed in via 1108 or 1110 to the payment checkout platform.

If the user is already a member of the loyalty program that is also recognized by the payment checkout platform (e.g., the user is agreeing to any applicable terms of the payment checkout platform and the merchant), the user is taken to 1114 to sign in to the loyalty program. The user may be proceeded to complete the checkout process using the payment checkout platform at 1120. If, on the other hand, the user is not already a member of the loyalty program, the user will be directed to 1116 to create an account with the loyalty program. At 1118, the information needed to complete the enrollment of the loyalty program will be provided by the checkout platform profile, for example, such that the enrollment process is seamless to the user. The user may just need to confirm the accuracy of the information. Once that is completed, the user may proceed to complete the checkout process using the payment checkout platform at 1120.

As a result of the system and method, known data may be communicated in a format that is secure and is known to additional program providers such as loyalty providers. In the past, the loyalty provider would have to analyze the data to determine which parts of the data related to an address, which parts of the data related to a zip code, etc. The claimed system and method provides a uniform method of communicated data which results in additional efficiency and more accurate transferal of data. Finally, by using known formats, unknown formats may immediately be flagged as being risky and possibly fraudulent.

FIG. 12 may be a high level illustration of some of the elements a sample computing system that may be physically configured to implement the method and system. The computing system may be a dedicated computing device 841, a dedicated portable computing device 801, an application on the computing device 841, an application on the portable computing device 801 or a combination of all of these. FIG. 13 may be a high level illustration of a portable computing device 801 communicating with a remote computing device 841 but the application may be stored and accessed in a variety of ways. In addition, the application may be obtained in a variety of ways such as from an app store, from a web site, from a store Wi-Fi system, etc. There may be various versions of the application to take advantage of the benefits of different computing devices, different languages and different API platforms.

In one embodiment, a portable computing device 801 may be a device that operates using a portable power source 855 such as a battery. The portable computing device 801 may also have a display 802 which may or may not be a touch sensitive display. More specifically, the display 802 may have a capacitance sensor, for example, that may be used to provide input data to the portable computing device 801. In other embodiments, an input pad 804 such as arrows, scroll wheels, keyboards, etc., may be used to provide inputs to the portable computing device 801. In addition, the portable computing device 801 may have a microphone 806 which may accept and store verbal data, a camera 808 to accept images and a speaker 810 to communicate sounds.

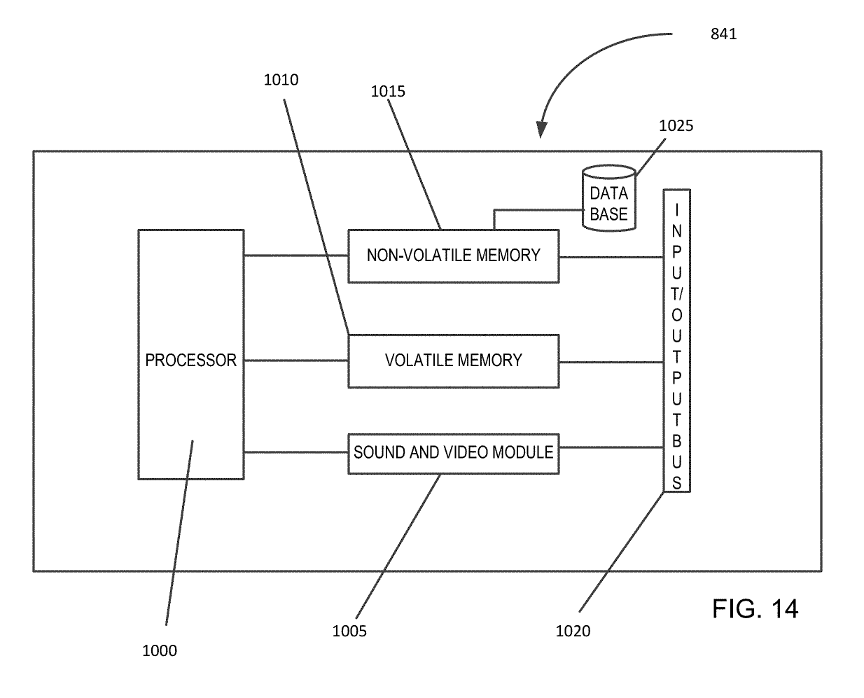

The portable computing device 801 may be able to communicate with a computing device 841 or a plurality of computing devices 841 that make up a cloud of computing devices 811. The portable computing device 801 may be able to communicate in a variety of ways. In some embodiments, the communication may be wired such as through an Ethernet cable, a USB cable or RJ6 cable. In other embodiments, the communication may be wireless such as through Wi-Fi (802.11 standard), Bluetooth, cellular communication or near field communication devices. The communication may be direct to the computing device 841 or may be through a communication network 102 such as cellular service, through the Internet, through a private network, through Bluetooth, etc. FIG. 13 may be a simplified illustration of the physical elements that make up a portable computing device 801 and FIG. 14 may be a simplified illustration of the physical elements that make up a server type computing device 841.

FIG. 13 may be a sample portable computing device 801 that is physically configured according to be part of the system. The portable computing device 801 may have a processor 850 that is physically configured according to computer executable instructions. It may have a portable power supply 855 such as a battery which may be rechargeable. It may also have a sound and video module 860 which assists in displaying video and sound and may turn off when not in use to conserve power and battery life. The portable computing device 801 may also have volatile memory 865 and non-volatile memory 870. It may have GPS capabilities 880 that may be a separate circuit or may be part of the processor 850. There also may be an input/output bus 875 that shuttles data to and from the various user input devices such as the microphone 806, the camera 808 and other inputs, such as the input pad 804, the display 802, and the speakers 810, etc. It also may control of communicating with the networks, either through wireless or wired devices. Of course, this is just one embodiment of the portable computing device 801 and the number and types of portable computing devices 801 is limited only by the imagination.

As a result of the system, better information may be provided to a user at a point of sale. The information may be user specific and may be required to be over a threshold of relevance. As a result, users may make better informed decisions. The system is more than just speeding a process but uses a computing system to achieve a better outcome.

The physical elements that make up the remote computing device 841 may be further illustrated in FIG. 14. At a high level, the computing device 841 may include a digital storage such as a magnetic disk, an optical disk, flash storage, non-volatile storage, etc. Structured data may be stored in the digital storage such as in a database. The server 841 may have a processor 1000 that is physically configured according to computer executable instructions. It may also have a sound and video module 1005 which assists in displaying video and sound and may turn off when not in use to conserve power and battery life. The server 841 may also have volatile memory 1010 and non-volatile memory 1015.

The database 1025 may be stored in the memory 1010 or 1015 or may be separate. The database 1025 may also be part of a cloud of computing device 841 and may be stored in a distributed manner across a plurality of computing devices 841. There also may be an input/output bus 1020 that shuttles data to and from the various user input devices such as the microphone 806, the camera 808, the inputs such as the input pad 804, the display 802, and the speakers 810, etc. The input/output bus 1020 also may control of communicating with the networks, either through wireless or wired devices. In some embodiments, the application may be on the local computing device 801 and in other embodiments, the application may be remote 841. Of course, this is just one embodiment of the server 841 and the number and types of portable computing devices 841 is limited only by the imagination.

The claimed system and method may address several technical problems and challenges, some of which are described. Currently, entering potential sensitive data across networks makes users nervous. By using a proprietary network such as a payment network, to transfer potentially sensitive data, security may be higher and users may be more open to joining additional beneficial programs. Similarly, moving data from one payment system to another loyalty system has felt risky to some users, but by using a proprietary, trusted network, the data may be communicated in a more trustworthy fashion. In addition, formatting data and communicating data in a manner which may be understood by a variety of additional programs is a technical challenge or problem which the system and method has addressed.

The user devices, computers and servers described herein may be general purpose computers that may have, among other elements, a microprocessor (such as from the Intel Corporation, AMD or Motorola); volatile and non-volatile memory; one or more mass storage devices (i.e., a hard drive); various user input devices, such as a mouse, a keyboard, or a microphone; and a video display system. The user devices, computers and servers described herein may be running on any one of many operating systems including, but not limited to WINDOWS, UNIX, LINUX, MAC OS, or Windows (XP, VISTA, etc.). It is contemplated, however, that any suitable operating system may be used for the present invention. The servers may be a cluster of web servers, which may each be LINUX based and supported by a load balancer that decides which of the cluster of web servers should process a request based upon the current request-load of the available server(s).

The user devices, computers and servers described herein may communicate via networks, including the Internet, WAN, LAN, Wi-Fi, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated.

The present disclosure provides a solution to the long-felt need described above. In particular, the systems and methods described herein may be configured for improving payment systems. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

What is claimed is:

1. A system for registering a user across different information platforms, wherein comprising:
a processor configured for executing processor-executable instructions;
a data store for storing information, said data store being accessible by the processor via a communications network;
an interface for providing messages to a user;
wherein the processor executes processor-executable instructions to provide via the interface a first user interface (UI) requesting the user to provide information to register with a payment checkout platform;
wherein the data store stores the provided information from the user in a user profile;
in response to the stored information, wherein the processor executes processor-executable instructions to provide via the interface a second UI requesting the user to register a loyalty program via the communications network hosted by a second information platform associated with a merchant, wherein the merchant is different from the payment checkout platform;
in response to the user approving to register the loyalty program, wherein the processor executes processor-executable instructions to provide a portion of the stored information from the data store to the second information platform to register the user to the loyalty program;
wherein the data store stores information associated with the loyalty program in the user profile; and
wherein the processor executes processor-executable instructions to process transactions during checkout for the user via the payment checkout platform as a result of the information associated with the loyalty program in the user profile.

2. The system of claim 1, wherein the processor executes processor-executable instructions to process transactions during the checkout comprises process promotional transactions from the merchant.

3. The system of claim 1, wherein the processor executes processor-executable instructions to process transactions during the checkout comprises process transactions of items or services provided from the merchant.

4. The system of claim 1, wherein the processor executes processor-executable instructions to process transactions during the checkout comprises process transactions of items or services provided from another merchant.

5. The system of claim 4, wherein the another merchant comprises a vendor having an established agreement with the merchant and the payment checkout platform.

6. The system of claim 1, wherein the processor further receives location-identifying information, and wherein processor executes processor-executable instructions to process transactions during checkout for the user via the payment checkout platform by incorporating the loyalty program of the merchant associated with the received location-identifying information.

7. A system for registering a user across different transactional platforms comprising:
a transaction server configured for executing processor-executable instructions;
a data store for storing information, said data store being accessible by the transaction server via a communications network;
an interface for providing messages to a user;
wherein the transaction server executes processor-executable instructions to provide via the interface a first user interface (UI) requesting the user to provide information to register with a first transactional platform;
wherein the data store stores the provided information from the user in a user profile;
in response to the stored information, wherein the transaction server executes processor-executable instructions to provide via the interface a second UI requesting the user to register a loyalty program via the communications network hosted by a second transactional platform associated with a merchant, wherein the merchant is different from the first transactional platform;
in response to the user registering the loyalty program, wherein the transaction server executes processor-executable instructions to provide a portion of the stored information from the data store to the second transactional platform to complete registering the user to the loyalty program;
wherein the data store stores information associated with the loyalty program in the user profile; and
wherein the transaction server executes processor-executable instructions to process checkout for the user via the first transactional platform as a result of the information associated with the loyalty program in the user profile.

8. The system of claim 7, wherein the processor executes processor-executable instructions to process the checkout comprises process promotional transactions from the merchant.

9. The system of claim 7, wherein the processor executes processor-executable instructions to process the checkout comprises process transactions of items or services provided from the merchant.

10. The system of claim 7, wherein the processor executes processor-executable instructions to process the checkout comprises process transactions of items or services provided from another merchant.

11. The system of claim 10, wherein the another merchant comprises a vendor having an established agreement with the merchant and the first transactional platform.

12. The system of claim 7, wherein the processor further receives location-identifying information, and wherein processor executes processor-executable instructions to process transactions during checkout for the user via the first transactional platform by incorporating the loyalty program of the merchant associated with the received location-identifying information.

13. A processor-executable method for registering a user across different transactional platforms comprising:
providing a first user interface (UI) to request a user to provide information to register with a first transactional platform;
storing the provided information from the user in a user profile in a data store;
in response to the stored information, providing a second UI requesting the user to register a loyalty program via a communications network hosted by a second transactional platform associated with a merchant, wherein the merchant is different from the first transactional platform;
during registering for the loyalty program, providing a portion of the stored information from the data store to the second transactional platform to complete registering the user to the loyalty program;
storing information associated with the loyalty program in the user profile; and
processing transactions during checkout for the user via the first transactional platform as a result of the information associated with the loyalty program in the user profile.

14. The processor-executable method of claim 13, wherein processing transactions comprises processing the transactions during checkout for the user via an electronic payment checkout platform.

15. The processor-executable method of claim 13, wherein processing the transaction checkout comprises processing transactions of items or services provided from the merchant.

16. The processor-executable method of claim 13, wherein processing the transaction checkout comprises processing transactions of items or services provided from another merchant.

17. The processor-executable method of claim 16, wherein the another merchant comprises a vendor having an established agreement with the merchant and the first transactional platform.

18. The processor-executable method of claim 13, further comprising receiving location-identifying information associated with the user, and wherein processing transactions during checkout for the user via the first transactional platform comprises processing transactions during checkout for the user via the first transactional platform with the loyalty program of the merchant associated with the received location-identifying information.

19. The processor-executable method of claim 13, further comprising, during registering for the loyalty program, displaying the provided portion of the stored information from the data store to the second transactional platform to complete registering the user to the loyalty program.
